(19) United States
(12) Patent Application Publication
(10) Pub. No.: US 2019/0391837 A1
(43) Pub. Date: Dec. 26, 2019

(54) PROCESSING DIVISION DEVICE, SIMULATOR SYSTEM AND PROCESSING DIVISION METHOD

(71) Applicant: MITSUBISHI ELECTRIC CORPORATION, Tokyo (JP)

(72) Inventor: Kanako GYOTA, Tokyo (JP)

(73) Assignee: MITSUBISHI ELECTRIC CORPORATION, Tokyo (JP)

(21) Appl. No.: 16/480,580

(22) PCT Filed: Mar. 3, 2017
(86) PCT No.: PCT/JP2017/008552

§ 371 Date: Jul. 24, 2019

(51) Int. Cl. G06F 9/455; G06F 9/48

(52) U.S. Cl. CPC G06F 9/45558; H04L 67/10; G06F 9/4881

(57) ABSTRACT

A processing division device (10) acquires a performance measurement result (33) from each of a plurality of simulators (20), and calculates a weight (34) for each simulator (20) in accordance with the acquired performance measurement result (33). When the weight (34) is calculated, the processing division device (10) divides a target process (31) to generate a division process (35) to be assigned to the simulator (20) such that a processing amount of the division process (35) assigned to each simulator (20) is to be a processing amount according to the weight (34) for each simulator (20).

### TECHNICAL FIELD

The present invention relates to a simulation technology that simulates an operation of a target system.

### BACKGROUND ART

There is a simulation technology that simulates an operation of a target system with a computer, by linking an instruction set simulation (hereinafter described as CPU instruction simulation) and IO simulation.

The CPU instruction simulation is a block that includes an instruction set simulator (ISS) instruction execution unit and simulates an instruction processing operation and a program counter. The IO simulation is a block that simulates an operation of input output (IO) of a target system. The IO of the target system refers to an input from an input device or network and an output to a display device or network.

A simulator using this simulation technology can realize cycle processing similar to that of the target system. Further, a simulator using this simulation technology can execute processing as in a case of executing a process in the target system by executing processing acquired from the outside, and can output a calculation result. As a specific example, by externally acquiring and executing a machining program, the simulator can execute the machining program in the same way as a case where the machining program is executed on the target system, and output a similar calculation result.

When a large amount of processing is executed by the simulator, it takes time to output a calculation result. Therefore, for executing a large amount of processing on the simulator, a simulator system is used that divides the large amount of processing into a plurality of division processes, distributes each division process to each of multiple collaborative simulators, and executes simulations in parallel. This allows the simulator system to execute a large amount of processing in parallel, enabling calculation results to be outputted at high speed.

There is a method for realizing a simulator system using a cloud system (see Patent Literature 1). Cloud systems provide users with services using hardware resources and software resources. In cloud systems, it is possible to run multiple virtual machines at the same time. By running multiple virtual machines in the cloud system and executing simulations in parallel in individual virtual machines, it is possible to execute the simulations in parallel.

### CITATION LIST

### Patent Literature

Patent Literature 1: JP 2016-103179 A

### SUMMARY OF INVENTION

### Technical Problem

In a case of running multiple virtual machines in a cloud system and executing simulations in parallel by individual virtual machines, variations may occur in processing times of simulations executed by individual virtual machines. If variations occur in processing times of simulations executed by individual virtual machines, the entire processing is adjusted to the processing time of the virtual machine with the slow processing time, and the processing time of the entire simulation is also delayed.

In a cloud system, a plurality of services may be operated at the same time, and a plurality of users may share and use one computer resource. Therefore, there is no guarantee of performance in the cloud system, and an actual performance differs depending on the timing at which the computer resources are acquired. This causes variations of the processing time to occur.

An object of the present invention is to suppress performance degradation of a simulator system.

### Solution to Problem

A processing division device according to the present invention includes:

a weight calculation unit to acquire a performance measurement result from each of a plurality of simulators, and calculate a weight for each simulator in accordance with the acquired performance measurement result; and

a division unit to divide a target process to generate a division process to be assigned to each simulator, such that a processing amount of the division process assigned to each simulator is to be a processing amount according to the weight for each simulator.

### Advantageous Effects of Invention

In the present invention, performance measurement results are sequentially obtained, and weights for individual simulators are calculated in accordance with the performance measurement results. Then, a target process is divided and a division process to be assigned to each simulator is generated such that a processing amount corresponds to the weight for each simulator. This causes a division process of a processing amount according to the performance measurement result to be dynamically assigned to each simulator. As a result, it is possible to suppress a delay of the processing time of the entire simulation due to some of the simulators.

### BRIEF DESCRIPTION OF DRAWINGS

FIG. 1 is a configuration diagram of a cloud system 200 in which a simulator system 100 according to a first embodiment operates.

FIG. 2 is a hardware configuration diagram of a physical machine 300 according to the first embodiment.

FIG. 3 is a hardware configuration diagram of a virtual machine 400 according to the first embodiment.

FIG. 4 is a hardware configuration diagram of a target machine 500 according to the first embodiment.

FIG. 5 is a configuration diagram of the simulator system 100.

FIG. 6 is a flowchart illustrating an overall operation of the simulator system 100 according to the first embodiment.

FIG. 7 is an explanatory view of a performance adjustment parameter 32 according to the first embodiment.

FIG. 8 is a flowchart illustrating an operation of a simulator 20 according to the first embodiment.

FIG. 9 is a flowchart illustrating an operation of a performance monitor 26 according to the first embodiment.

FIG. 10 is an explanatory view of a performance measurement result 33 and a weight 34 according to the first embodiment.

FIG. 11 is a flowchart illustrating an operation of a processing division device 10 according to the first embodiment.

### DESCRIPTION OF EMBODIMENTS

### First Embodiment

***Description of Configuration***

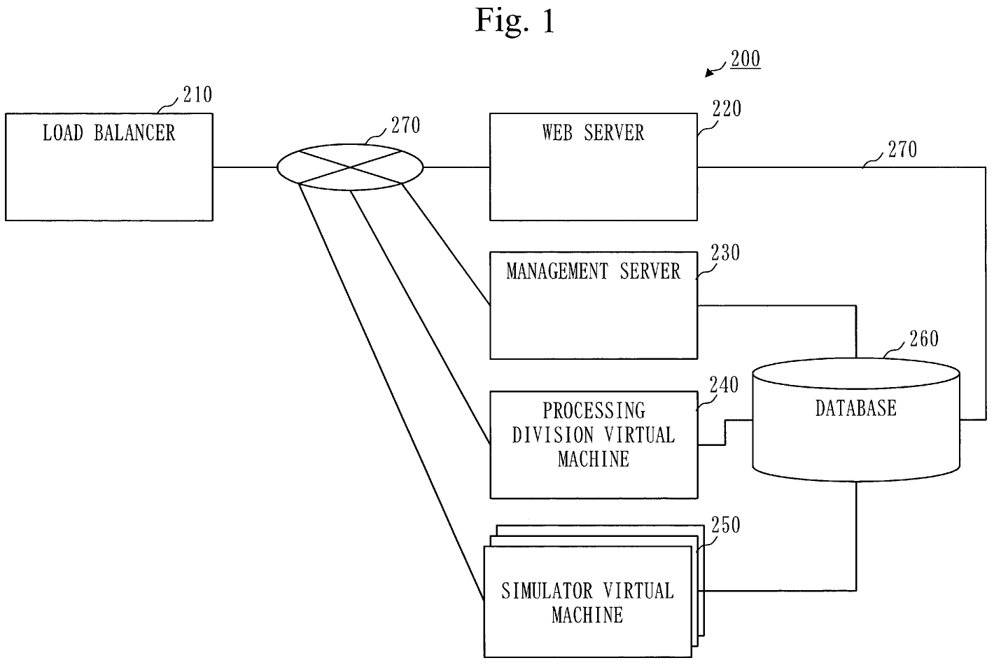

With reference to FIG. 1, a configuration of a cloud system 200 in which a simulator system 100 according to a first embodiment operates will be described.

The cloud system 200 includes a load balancer 210, a web server 220, a management server 230, a processing division virtual machine 240, a plurality of simulator virtual machines 250, and a database server 260.

The load balancer 210, the web server 220, the management server 230, the processing division virtual machine 240, each simulator virtual machine 250, and the database server 260 are connected via a network 270.

The load balancer 210 is a device that distributes data and requests uploaded by a user, to the web server 220, the management server 230, the processing division virtual machine 240, and each simulator virtual machine 250 via the network 270.

The web server 220 is a virtual machine to output a calculation result to the user.

The management server 230 is a virtual machine that controls the cloud system 200 via the network 270.

The processing division virtual machine 240 is a virtual machine that realizes a processing division device 10.

The simulator virtual machine 250 is a virtual machine that realizes a simulator 20.

The database server 260 is a storage device that stores data outputted from the processing division device 10 and the simulator 20.

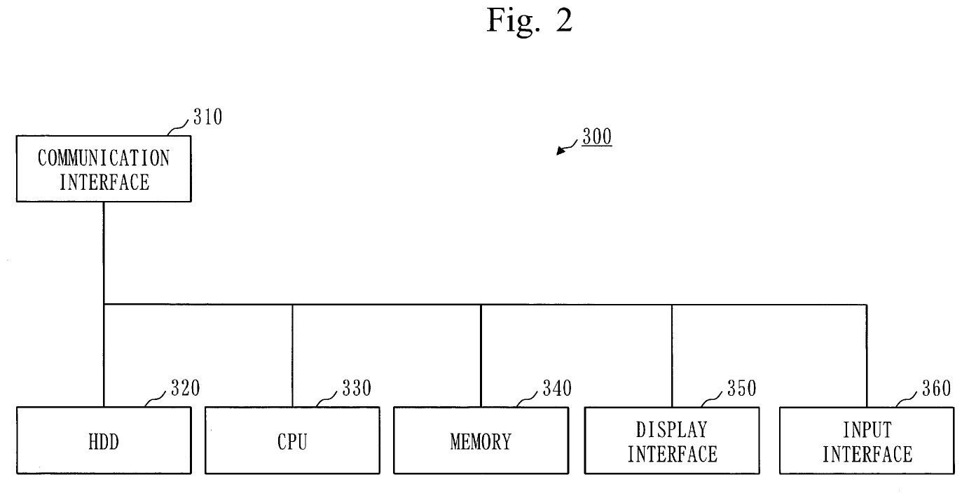

With reference to FIG. 2, a description is given to a hardware configuration of a physical machine 300 on which the web server 220, the management server 230, the processing division virtual machine 240, and the plurality of simulator virtual machines 250 operate, according to the first embodiment.

The physical machine 300 includes a communication interface 310, a hard disk drive (HDD) 320, a central processing unit (CPU) 330, a memory 340, a display interface 350, and an input interface 360.

The communication interface 310 is an interface to communicate with external devices. The communication interface 310 is, as a specific example, a port of Ethernet (registered trademark).

The HDD 320 is a storage device that stores data. The physical machine 300 may include a solid state drive (SSD) instead of the HDD 320. In addition, instead of the HDD 320, the physical machine 300 may include a portable storage medium such as a secure digital (SD, registered trademark) memory card, a compact flash (CF), a NAND flash, a flexible disk, an optical disk, a compact disk, a Blu-Ray (registered trademark) disk, or a digital versatile disk (DVD).

The CPU 330 is an integrated circuit (IC) that performs arithmetic processing. Instead of the CPU 330 or in addition to the CPU 330, the physical machine 300 may include a digital signal processor (DSP) or a graphics processing unit (GPU).

The memory 340 is a storage device that temporarily stores data. As a specific example, the memory 340 is a static random access memory (SRAM) or dynamic random access memory (DRAM).

The display interface 350 is an interface to be connected with a display device 351. As a specific example, the display interface 350 is a port of a high-definition multimedia interface (HDMI) (registered trademark).

The input interface 360 is an interface to be connected with an input device 361. As a specific example, the input interface 360 is a port of a universal serial bus (USB) terminal.

Meanwhile, the load balancer 210 and the database server 260 may have a same hardware configuration as that of the physical machine 300. The database server 260 may have a plurality of HDDs and may be configured as redundant arrays of inexpensive disks (RAID).

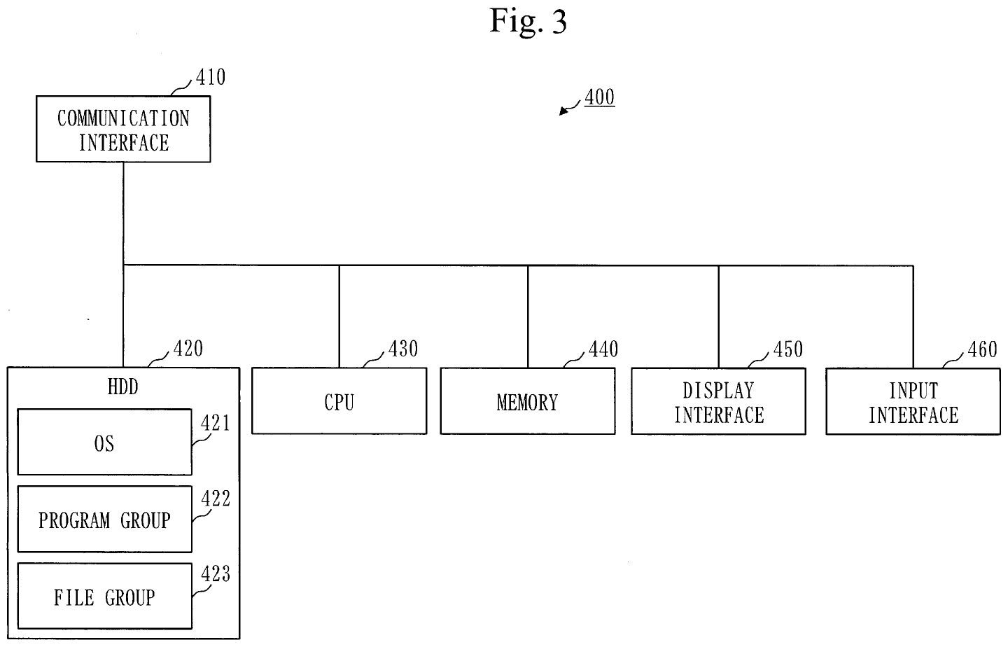

With reference to FIG. 3, a hardware configuration of a virtual machine 400 of the web server 220, the management server 230, the processing division virtual machine 240, and the plurality of simulator virtual machines 250 according to the first embodiment will be described.

The virtual machine 400 includes a communication interface 410, an HDD 420, a CPU 430, a memory 440, a display interface 450, and an input interface 460.

The Communication interface 410, the HDD 420, the CPU 430, the memory 440, the display interface 450, and the input interface 460 respectively are the communication interface 310, the HDD 320, the CPU 330, the memory 340, the display interface 350, and the input interface 360 provided in the physical machine 300 that realizes the virtual machine 400. The HDD 420 stores an OS 421, a program group 422, and a file group 423, for realization of the virtual machine 400.

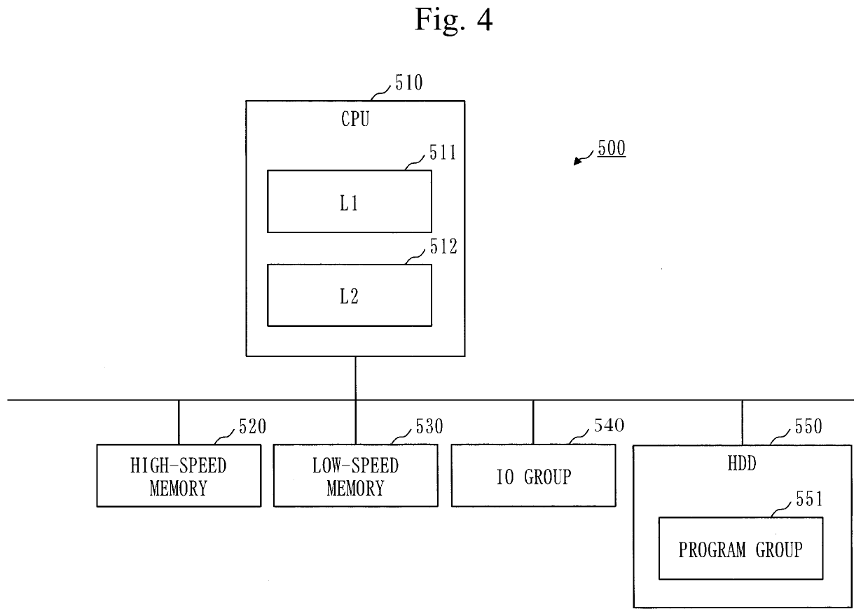

With reference to FIG. 4, a hardware configuration of a target machine 500 according to the first embodiment will be described.

The target machine 500 is a device whose operation is simulated by the simulator system 100. The target machine 500 performs servo communication with a servo mechanism, for example, to realize cycle processing.

The target machine 500 includes a CPU 510, a high-speed memory 520, a low-speed memory 530, an IO group 540, and an HDD 550.

The CPU 510 is an IC that performs arithmetic processing similarly to the CPU 330. The CPU 510 includes an L1 cache 511 and an L2 cache 512, and can execute processing at relatively high speed.

The high-speed memory 520 and the low-speed memory 530 are storage devices that temporarily store data, similarly to the memory 340. As a specific example, the high-speed memory 520 is an SRAM, and the low-speed memory 530 is a DRAM.

The IO group 540 is a device group that performs input and output with peripheral devices. As a specific example, the IO group 540 is a device that performs servo communication with a servo mechanism.

Similarly to the HDD 320, the HDD 550 is a storage device that stores data. Similarly to the HDD 320, the HDD 550 may be an SSD or a portable storage medium. The HDD 550 stores a program group 551 that realizes functions of the target machine 500.

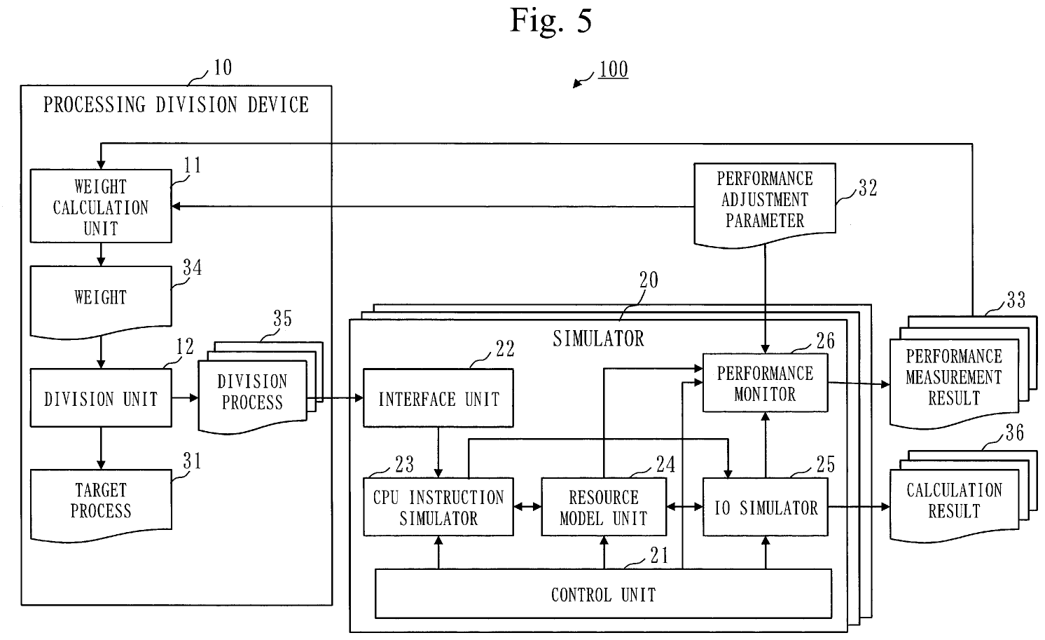

With reference to FIG. 5, a configuration of the simulator system 100 will be described.

The simulator system 100 includes the processing division device 10 and a plurality of simulators 20.

The processing division device 10 includes a weight calculation unit 11 and a division unit 12 as functional components. Functions of the weight calculation unit 11 and the division unit 12 are realized by software.

The HDD 420 of the virtual machine 400 that realizes the processing division device 10 stores a program that realizes the functions of the weight calculation unit 11 and the division unit 12, as the program group 422. This program is read into the memory 440 by the CPU 430 and executed by the CPU 430. This allows the functions of the weight calculation unit 11 and the division unit 12 to be realized.

Each simulator 20 includes a control unit 21, an interface unit 22, a CPU instruction simulator 23, a resource model unit 24, an IO simulator 25, and a performance monitor 26 as functional components. Functions of the control unit 21, the interface unit 22, the CPU instruction simulator 23, the resource model unit 24, the IO simulator 25 and the performance monitor 26 are realized by software.

The HDD 420 of the virtual machine 400 that realizes the simulator 20 stores a program that realizes the functions of the control unit 21, the interface unit 22, the CPU instruction simulator 23, the resource model unit 24, the IO simulator 25, and the performance monitor 26. This program is read into the memory 440 by the CPU 430 and executed by the CPU 430. This allows the functions of the control unit 21, the interface unit 22, the CPU instruction simulator 23, the resource model unit 24, the IO simulator 25, and the performance monitor 26 to be realized.

***Description of Operation***

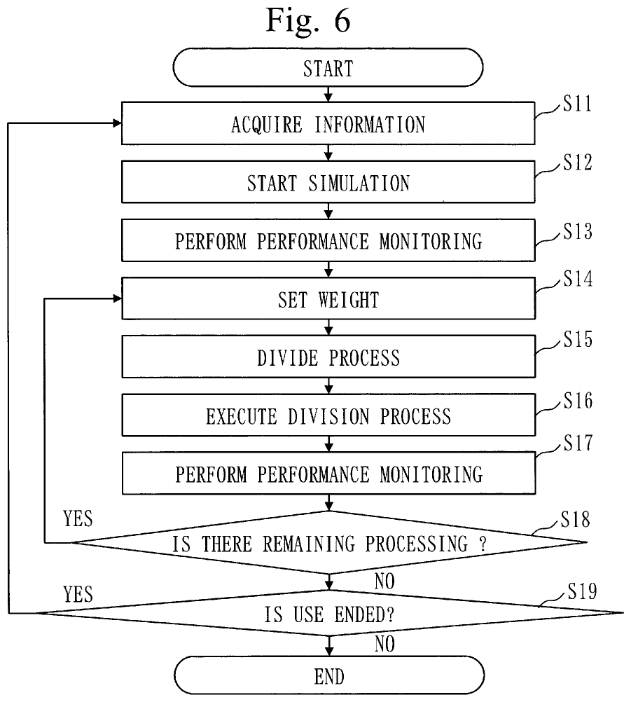

With reference to FIGS. 6 to 11, an operation of the simulator system 100 according to the first embodiment will be described.

Among operations of the simulator system 100 according to the first embodiment, an operation of the processing division device 10 corresponds to a processing division method according to the first embodiment. Further, among operations of the simulator system 100 according to the first embodiment, an operation of the processing division device 10 corresponds to processing of a processing division program according to the first embodiment.

With reference to FIG. 6, an overall operation of the simulator system 100 according to the first embodiment will be described.

(Step S11: Information Acquisition Process)

The management server 230 of the cloud system 200 acquires a target process 31 that is a process to be executed, and a performance adjustment parameter 32 that is a parameter related to a setting of the simulator system 100.

Specifically, the target process 31 and the performance adjustment parameter 32 are uploaded to the simulator system 100 by a user. The management server 230 acquires the uploaded target process 31 and performance adjustment parameter 32, and writes into the database server 260.

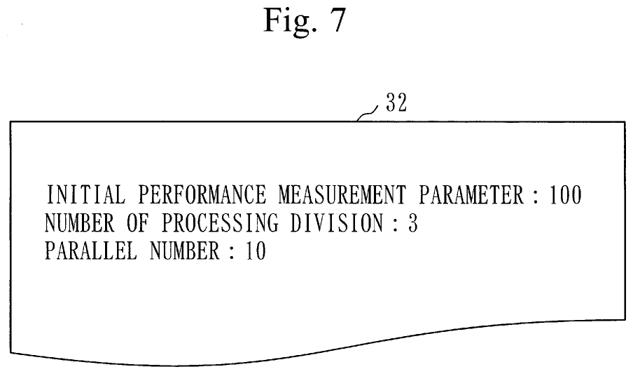

As illustrated in FIG. 7, the performance adjustment parameter 32 includes an initial performance measurement parameter, the number of processing divisions, and a parallel number.

The initial performance measurement parameter indicates a measurement section when the performance monitor 26 performs the initial performance measurement. In FIG. 7, since 100 is set as the initial performance measurement parameter, the performance monitor 26 performs performance measurement for 100 cycles when performing the initial performance measurement.

The number of processing divisions indicates the number of times to execute the processing division. In FIG. 7, since 3 is set as the number of processing divisions, the processing division is executed for three times.

The parallel number is the number of simulators 20 that execute the simulation in parallel. In FIG. 7, since 10 is set as the parallel number, the simulation is executed by 10 pieces of the simulator 20.

(Step S12: Simulation Start Process)

The management server 230 of the cloud system 200 activates the processing division device 10, and activates the simulators 20 of the parallel number included in the performance adjustment parameter 32 acquired in step S11. Then, the simulation of the target machine 500 is started in each activated simulator 20.

(Step S13: Initial Monitor Process)

The performance monitor 26 of each simulator 20 activated in step S12 measures a performance of the simulation started in step S12, to generate a performance measurement result 33. The performance monitor 26 writes the generated performance measurement result 33 into the database server 260.

(Step S14: Weight Setting Process)

The weight calculation unit 11 of the processing division device 10 acquires the performance measurement result 33 generated in step S13. Specifically, the weight calculation unit 11 reads the performance measurement result 33 from the database server 260.

Then, the weight calculation unit 11 calculates the weight 34 for each simulator in accordance with the acquired performance measurement result 33. The weight calculation unit 11 writes the calculated weight 34 into the database server 260.

(Step S15: Division Process)

The division unit 12 of the processing division device 10 acquires the weight 34 calculated in step S14. Specifically, the division unit 12 reads the weight 34 from the database server 260.

Then, the division unit 12 divides the target process 31 to generate a division process 35 to be assigned to each simulator 20, such that a processing amount of the division process 35 assigned to each simulator 20 is to be a processing amount according to the weight 34 for each simulator 20. The division unit 12 writes each generated division process 35 into the database server 260, in association with an identifier of the target simulator 20.

(Step S16: Processing Execution Process)

Each simulator 20 acquires the division process 35 generated in step S15. Specifically, the simulator 20 reads, from the database server 260, the division process 35 associated with its own identifier. Then, each simulator 20 executes the acquired division process 35. Each simulator 20 outputs an operation result 36 obtained as a calculation result of executing the division process 35.

(Step S17: Monitor Processing)

The performance monitor 26 of each simulator 20 activated in step S12 measures a performance when the division process 35 is executed in step S16, to generate the performance measurement result 33. The performance monitor 26 writes the generated performance measurement result 33 into the database server 260.

(Step S18: Remaining Determination Process)

The division unit 12 of the processing division device 10 determines whether or not unexecuted processing remains in the target process 31.

When the unexecuted processing remains, the division unit 12 returns the process to step S14. Whereas, when no unexecuted processing remains, the division unit 12 advances the process to step S19.

(Step S19: End Determination Process)

The management server 230 determines whether or not to end the use of the simulator system 100. As a specific example, when an instruction for executing a new process is not inputted from the user, it is determined that the use is to be ended, and when an instruction for executing a new process is inputted, it is determined that the use is not to be ended.

When the use is not to be ended, the management server 230 returns the process to step S11. Whereas, when the use is to be ended, the management server 230 ends the process.

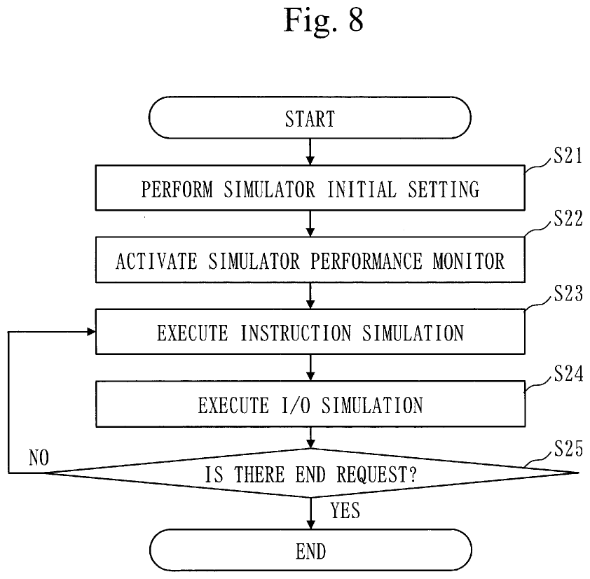

With reference to FIG. 8, an operation of the simulator 20 according to the first embodiment will be described.

The processing of step S21 to step S22 corresponds to the processing of step S12 of FIG. 6. Further, the processing of steps S23 to step S24 corresponds to the processing of step S12 to step S13 and the processing of step S16 to step S17 of FIG. 6.

(Step S21: Initial Setting Process)

When the simulator 20 is activated in step S12, the control unit 21 performs initial setting.

Specifically, the control unit 21 loads a program of the target machine 500 into the resource model unit 24. The resource model unit 24 is a function that simulates operations of the L1 cache and the L2 cache in the CPU 510 of the target machine 500, the high-speed memory 520, the low-speed memory 530, and the like. The control unit 21 sets a program counter. The control unit 21 sets a switching timing between the CPU instruction simulator 23 and the IO simulator 25. The switching timing is set, for example, by a threshold of the number of execution instructions. The control unit 21 sets a cycle processing time and a threshold of the number of execution instructions. The cycle processing time is a time interval at which IO simulation is periodically executed. The threshold of the number of execution instructions is an upper limit of the number of instructions executed by the CPU instruction simulator 23 in one instruction simulation.

(Step S22: Monitor Setting Process)

The control unit 21 activates the performance monitor 26. When activated, the performance monitor 26 sets a measurement section indicated by the initial performance measurement parameter included in the performance adjustment parameter 32 acquired in step S11. Further, the performance monitor 26 sets a cycle counter to 0, which is an initial value.

(Step S23: CPU Instruction Process)

The CPU instruction simulator 23 executes instruction simulation. The CPU instruction simulator 23 is a function that simulates an instruction processing operation and a program counter.

Specifically, the control unit 21 activates the CPU instruction simulator 23. When activated, the CPU instruction simulator 23 acquires an instruction from the resource model unit 24 and executes instruction simulation by using the set program counter.

When the division process 35 is generated, the CPU instruction simulator 23 acquires the division process 35 via the interface unit 22, and executes the division process 35. When starting execution of the division process 35, the CPU instruction simulator 23 writes into a state address of the resource model unit 24 that the division process 35 is in a state of being executed. The CPU instruction simulator 23 writes a calculation result 36 obtained by executing the division process 35, into a result address of the resource model unit 24.

At this time, the CPU instruction simulator 23 calls the IO simulator 25 to execute the IO simulation, in accordance with the processing to be executed.

The CPU instruction simulator 23 records the number of execution instructions. When the number of executed instructions reaches a threshold of the number of execution instructions, the CPU instruction simulator 23 records a value of the program counter at that time, stops instruction simulation, and transfers the execution authority to the control unit 21.

(Step S24: IO Process)

The IO simulator 25 executes IO simulation. The IO simulator 25 is a function that simulates the IO of the target machine 500, such as a keyboard, a display device, a servo communication, and a network. The IO simulators 25 exist separately for the number of IOs to be simulated.

Specifically, the control unit 21 activates the IO simulator 25. When activated, the IO simulator 25 calculates an elapsed virtual time by using the number of instructions executed by the CPU instruction simulator 23 in step S23. The virtual time is an estimated elapsed time on the target machine 500. The IO simulator 25 executes IO simulation such as servo communication when the elapsed virtual time reaches a cycle processing time. After finishing the IO simulation, the IO simulator 25 transfers the execution authority to the control unit 21.

At this time, the IO simulator 25 specifies whether or not the division process 35 is being executed, by referring to a state address of the resource model unit 24. When the division process 35 is in a state of being executed, the IO simulator 25 acquires the calculation result 36 from the result address of the resource model unit 24, and outputs the operation result 36.

(Step S25: End Determination Process)

The control unit 21 determines whether or not to end the process. Specifically, when it is determined that the unexecuted processing remains in step S18, the control unit 21 returns the process to step S33. Whereas, when it is determined that no unexecuted processing remains in step S18, the control unit 21 ends the process.

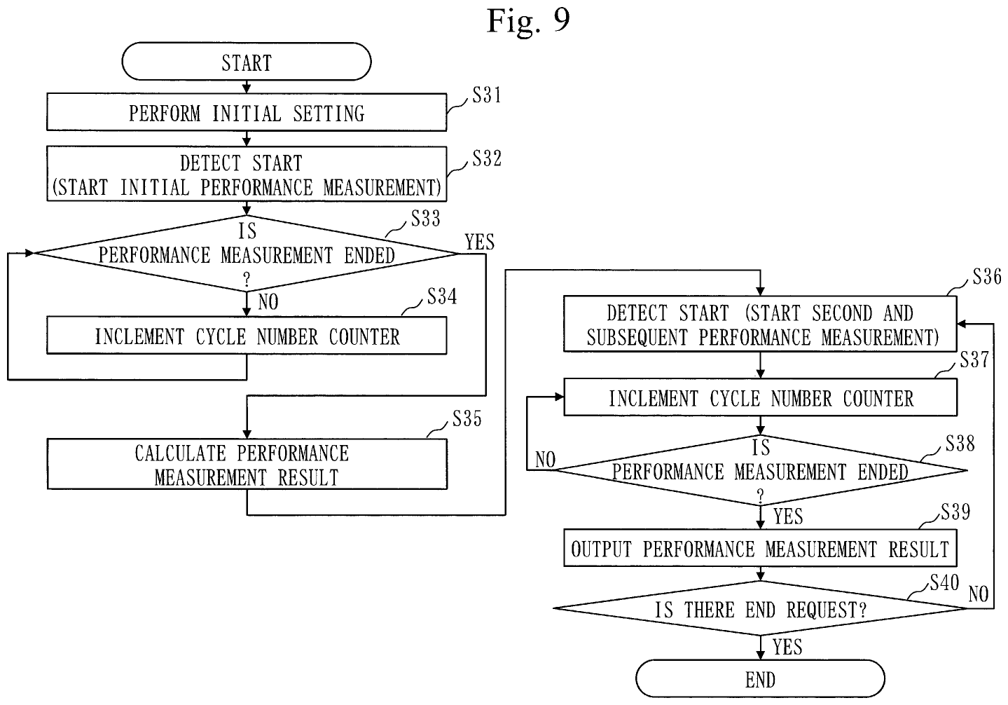

With reference to FIG. 9, an operation of the performance monitor 26 according to the first embodiment will be described.

The processing of step S31 corresponds to the processing of step S22 of FIG. 8.

The processing from step S32 to step S39 is executed when the processing from step S23 to step S24 of FIG. 8 is being executed. In particular, the processing from step S32 to step S35 is executed when the processing from step S23 to step S24 of FIG. 8 corresponding to step S12 to step S13 of FIG. 6 is being executed. Further, the processing of step S36 to step S39 is executed when the processing of step S23 to step S24 of FIG. 8 corresponding to step S16 to step S17 of FIG. 6 is being executed.

(Step S31: Initial Setting Process)

As described in step S22, the performance monitor 26 sets a measurement section indicated by the initial performance measurement parameter included in the performance adjustment parameter 32 acquired in step S11. Further, the performance monitor 26 sets the cycle counter to 0, which is an initial value.

(Step S32: Start Detection Process)

The performance monitor 26 monitors an operation of the IO simulator 25 and detects a start of cycle processing. Specifically, the performance monitor 26 monitors an operation of the IO simulator 25 by monitoring an execution state of IO simulation such as servo communication and a determined address of the resource model unit 24. Thus, the performance monitor 26 detects a start of cycle processing.

When having detected a start of cycle processing, the performance monitor 26 starts real-time measurement. Further, the performance monitor 26 increments a value of the cycle counter by one.

(Step S33: Measurement End Determination Process)

The performance monitor 26 determines whether or not the value of the cycle counter has reached the value indicated by the initial performance measurement parameter included in the performance adjustment parameter 32 acquired in step S11.

When the value indicated by the initial performance measurement parameter has not been reached, the performance monitor 26 advances the process to step S34. Whereas, when the value of the cycle counter has reached the value indicated by the initial performance measurement parameter, the performance monitor 26 advances the process to step S35.

In the example of FIG. 7, when the value of the cycle counter reaches 100, the process proceeds to step S35.

(Step S34: Cycle Count Process)

The performance monitor 26 monitors an operation of the IO simulator 25, and increments the value of the cycle counter by one when the IO simulation is executed. Then, the performance monitor 26 advances the process to step S33.

(Step S35: Measurement End Process)

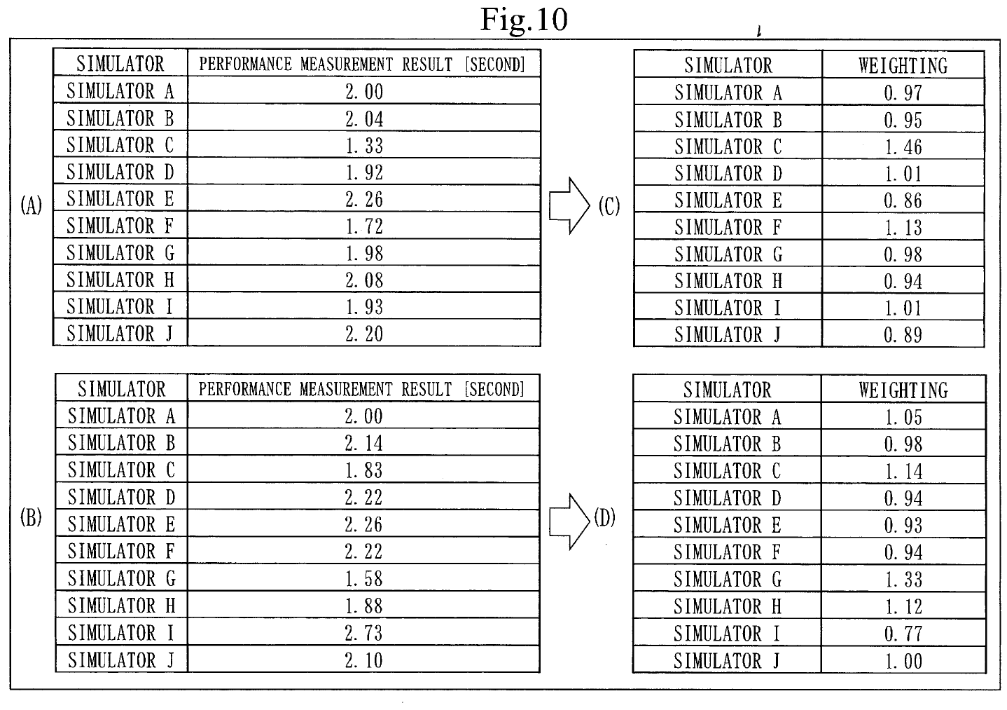

The performance monitor 26 ends the real-time measurement, and calculates a processing time per cycle from the measured real time. That is, the processing time per cycle=real time/a value indicated by initial performance measurement parameter. The performance monitor 26 writes the calculated processing time per cycle as the performance measurement result 33, into the database server 260. This causes generation of information of one row in (A) of FIG. 10.

The performance monitor 26 initializes the value of the cycle counter to 0.

(Step S36: Start Detection Process)

The performance monitor 26 periodically monitors a state address of the resource model unit 24, to detect that the division process 35 is brought into a state of being executed.

When having detected that the division process 35 is brought into a state of being executed, the performance monitor 26 starts real-time measurement.

(Step S37: Cycle Count Process)

The performance monitor 26 monitors an operation of the IO simulator 25, and increments the value of the cycle counter by one when the IO simulation is executed.

(Step S38: Measurement End Determination Process)

The performance monitor 26 periodically monitors a state address of the resource model unit 24, to detect that the state in which the division process 35 is being executed has ended. When having detected that the state in which the division process 35 is being executed has ended, the performance monitor 26 advances the process to step S39.

(Step S39: Measurement End Process)

The performance monitor 26 ends the real-time measurement, and calculates a processing time per cycle from the measured real time. That is, the processing time per cycle=the value of the real time/cycle counter. The performance monitor 26 writes the calculated processing time per cycle as the performance measurement result 33, into the database server 260. This causes generation of information of one row in (B) of FIG. 10.

The performance monitor 26 initializes the value of the cycle counter to 0.

(Step S40: End Determination Process)

The performance monitor 26 determines whether or not to end the process. Specifically, when it is determined that the unexecuted processing remains in step S18, the performance monitor 26 returns the process to step S36. Whereas, when it is determined that no unexecuted processing remains in step S18, the performance monitor 26 ends the process.

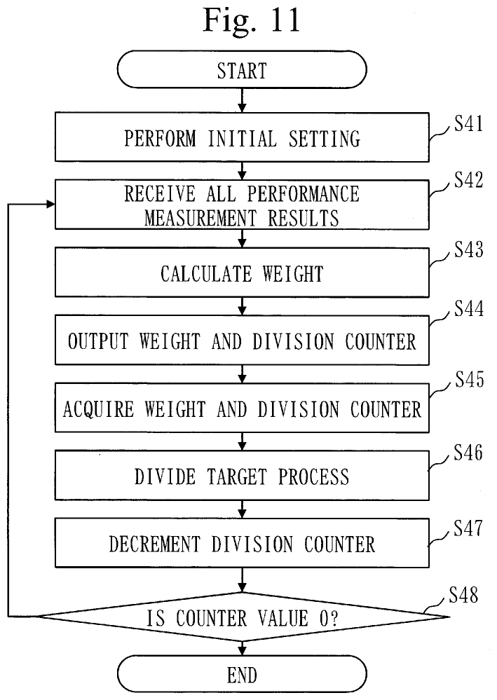

With reference to FIG. 11, an operation of the processing division device 10 according to the first embodiment will be described.

The processing of steps S41 to S44 corresponds to the processing of step S14 of FIG. 6. The processing of steps S45 to S48 corresponds to the processing of step S15 of FIG. 6.

(Step S41: Initial Setting Process)

The weight calculation unit 11 acquires the number of processing divisions and the parallel number included in the performance adjustment parameter 32 acquired in step S11. The weight calculation unit 11 sets the number of processing divisions in a division counter.

In the example of FIG. 7, 3 is acquired as the number of processing divisions, and 10 is acquired as the parallel number.

(Step S42: Performance Acquisition Process)

The weight calculation unit 11 acquires the performance measurement result 33 of each simulator 20. Specifically, the weight calculation unit 11 reads the performance measurement result 33 written into the database server 260 in step S35 or step S39 of FIG. 9.

(Step S43: Weight Calculation Process)

The weight calculation unit 11 calculates the weight 34 for each simulator in accordance with the performance measurement result 33 acquired in step S42.

Specifically, the weight calculation unit 11, with each simulator 20 as a target, divides an average value of values indicated by the performance measurement results 33 acquired from individual simulators by a value indicated by the performance measurement result acquired from the target simulator 20, to calculate the weight 34 for the target simulator 20.

In the example illustrated in (A) of FIG. 10, an average value of values indicated by the performance measurement results 33 of the 10 pieces of simulators 20 is 1.946. Therefore, as illustrated in (C) of FIG. 10, the weight of the simulator 20A is 19.46/2.00=0.973≈0.97.

(Step S44: Weight output process)

The weight calculation unit 11 outputs the weight 34 for each simulator 20 calculated in step S43 and the division counter. Specifically, the weight calculation unit 11 writes the weight 34 for each simulator 20 and the division counter into the database server 260.

(Step S45: Weight acquisition process)

The division unit 12 acquires the weight 34 for each simulator 20 and the division counter outputted in step S44. Specifically, the division unit 12 reads the weight 34 for each simulator 20 and the division counter, from the database server 260.

(Step S46: Processing division process)

The division unit 12 divides the target process 31 acquired in step S11 to generate the division process 35 to be assigned to each simulator 20, in accordance with the weight 34 for each simulator 20 acquired in step S45.

Specifically, the division unit 12 divides the target process 31 to generate the division process 35 to be assigned to each simulator 20, such that a processing amount of the division process 35 assigned to each simulator 20 is to be a processing amount according to the weight 34 for each simulator 20. That is, the division unit 12 generates the division process 35 such that a processing amount of the division process 35 increases as a value of the weight increases. Note that, since there may be a limitation in a position where the target process 31 can be divided and the like in some cases, a processing amount of the division process 35 may not exactly match the weight 34.

(Step S47: Division count process)

The division unit 12 decrements the division counter by one.

(Step S48: End determination process) The division unit 12 determines whether or not the division counter is 0. When the division counter is 0, the division unit 12 ends the process. Whereas, when the division counter is not 0, the process returns to step S42.

### Effect of First Embodiment

As described above, when the simulator system 100 according to the first embodiment executes the simulation in parallel by the plurality of simulators 20, performance measurement results are sequentially acquired, and the weight 34 for each simulator 20 is calculated in accordance with the performance measurement result 33. Then, in the simulator system 100 according to the first embodiment, the target process 31 is dynamically divided and the division process 35 to be assigned to each simulator 20 is generated such that a processing amount is to be in accordance with the weight 34 for each simulator 20. This makes it possible to suppress a delay of the processing time of the entire simulation due to some of the simulators 20. That is, by eliminating variations in the processing time of each simulator 20, it is possible to suppress a delay of the processing time of the entire simulation.

Cloud systems are used by multiple users. Therefore, computer resource assignment changes dynamically, and the performance of the simulator 20 also changes dynamically. That is, even if performance measurement and load distribution are executed first, the computer resources available to individual simulators 20 change from the beginning and the performance of the simulators 20 changes, by another user using computer resources while the simulation is running. Since the simulator system 100 according to the first embodiment dynamically performs load distribution, it is possible to suppress a delay of the processing time of the entire simulation.

***Other Configuration***

<Modification 1>

In the first embodiment, exchange of data between individual devices and exchange of data between individual functional components are performed through the database server 260. However, exchange of data between individual devices may be performed by transmitting and receiving data via the network 270. Moreover, exchange of data between individual functional components may be performed by inter-process communication.

### REFERENCE SIGNS LIST

10: processing division device, 11: weight calculation unit, 12: division unit, 20: simulator, 21: control unit, 22: interface unit, 23: CPU instruction simulator, 24: resource model unit, 25: IO simulator, 26: performance monitor, 31: target process, 32: performance adjustment parameter, 33: performance measurement result, 34: weight, 35: a division process, 100: simulator system, 200: cloud system, 210: load balancer, 220: web server, 230: management server, 240: processing division virtual machine, 250: simulator virtual machine, 260: database server, 270: network, 300: physical machine, 310: communication interface, 320: HDD, 330: CPU, 340: memory, 350: display interface, 360: input interface, 400: virtual machine, 410: communication interface, 420: HDD, 430: CPU, 440: memory, 450: display interface, 460: input interface, 500: target machine, 510: CPU, 520: high-speed memory, 530: low-speed memory, 540: IO group, 550: HDD.

1-8. (canceled)

9. A processing division device comprising:
processing circuitry to:
acquire a performance measurement result of each simulator measured while a plurality of simulators execute simulations, for a measurement section indicated by an initial performance measurement parameter included in a performance adjustment parameter, the measurement section indicating the number of executions of a target process for performance measurement, and calculate a weight for each simulator in accordance with the acquired performance measurement result; and
divide the target process to generate a division process to be assigned to each simulator, such that a processing amount of the division process assigned to each simulator is to be a processing amount according to the weight for each simulator,
wherein a process is repeated the number of times indicated by the number of processing divisions included in the performance adjustment parameter, the process being such that the processing circuitry acquires a performance measurement result measured while the generated division process is executed by each assigned simulator, re-calculates a weight for each simulator in accordance with the acquired performance measurement result, and divides the target process based on the re-calculated weight to re-generate a division process to be assigned to each simulator.

10. The processing division device according to claim 9, wherein
the processing circuitry divides, with each simulator as a target, an average value of the performance measurement result acquired from each simulator, by the performance measurement result acquired from a target simulator, to calculate the weight for the target simulator.

11. The processing division device according to claim 10, wherein
the processing circuitry generates the division process to allow a processing amount of the division process increases as a value of the weight increases.

12. The processing division device according to claim 9, wherein
each simulator includes a performance monitor to measure performance, and
the processing circuitry acquires a performance measurement result measured by a performance monitor provided to each simulator.

13. The processing division device according to claim 10, wherein
each simulator includes a performance monitor to measure performance, and
the processing circuitry acquires a performance measurement result measured by a performance monitor provided to each simulator.

14. The processing division device according to claim 11, wherein
each simulator includes a performance monitor to measure performance, and
the processing circuitry acquires a performance measurement result measured by a performance monitor provided to each simulator.

15. The processing division device according to claim 9, wherein
each simulator operates in a cloud system.

16. The processing division device according to claim 10, wherein
each simulator operates in a cloud system.

17. The processing division device according to claim 11, wherein
each simulator operates in a cloud system.

18. The processing division device according to claim 12, wherein
each simulator operates in a cloud system.

19. The processing division device according to claim 13, wherein
each simulator operates in a cloud system.

20. The processing division device according to claim 14, wherein
each simulator operates in a cloud system.

21. A simulator system comprising:
a plurality of simulators; and a processing division device to divide a target process to generate a division process to be assigned to each simulator, wherein
the processing division device comprises:
processing circuitry to:
acquire a performance measurement result of each simulator measured while the plurality of simulators execute simulations, for a measurement section indicated by an initial performance measurement parameter included in a performance adjustment parameter, the measurement section indicating the number of executions of the target process for performance measurement, and calculate a weight for each simulator in accordance with the acquired performance measurement result; and
divide the target process to generate the division process to be assigned to each simulator, such that a processing amount of the division process assigned to each simulator is to be a processing amount according to the weight for each simulator,
wherein a process is repeated the number of times indicated by the number of processing divisions included in the performance adjustment parameter, the process being such that the processing circuitry acquires a performance measurement result measured while the generated division process is executed by each assigned simulator, re-calculates a weight for each simulator in accordance with the acquired performance measurement result, and divides the target process based on the re-calculated weight to re-generate a division process to be assigned to each simulator.

22. A processing division method comprising:
acquiring a performance measurement result of each simulator measured while a plurality of simulators execute simulations, for a measurement section indicated by an initial performance measurement parameter included in a performance adjustment parameter, the measurement section indicating the number of executions of a target process for performance measurement, and calculating a weight for each simulator in accordance with the acquired performance measurement result;
dividing the target process to generate a division process to be assigned to each simulator, such that a processing amount of the division process assigned to each simulator is to be a processing amount according to the weight for each simulator; and
repeating a process the number of times indicated by the number of processing divisions included in the performance adjustment parameter, the process being acquiring a performance measurement result measured while the generated division process is executed by each assigned simulator, re-calculating a weight for each simulator in accordance with the acquired performance measurement result, and dividing the target process based on the re-calculated weight to re-generate a division process to be assigned to each simulator.
